(19) United States
(12) Patent Application Publication
(10) Pub. No.: US 2011/0129316 A1
(43) Pub. Date: Jun. 2, 2011

(54) FASTENING ASSEMBLY

(75) Inventors: Peter Julian Owen, Saffron Walde (GB); Jonathan Bloy, Cambridgeshire (GB)

(73) Assignee: RAPTORGRIP LIMITED, Leeds (UK)

(21) Appl. No.: 12/936,311

(22) PCT Filed: Apr. 3, 2009
(86) PCT No.: PCT/GB2009/000896

§ 371 Date: Jan. 24, 2011

(30) Foreign Application Priority Data
Apr. 3, 2008 (GB) 0806051.9

(51) Int. Cl. F16B 39/28; F16B 35/06

(52) U.S. Cl. 411/87; 411/387.1; 411/166

(57) ABSTRACT

A fastening assembly for attachment of objects (1) to substrates (2) formed from friable materials, such as plasterboard, includes one or more longitudinal pins (8) having threaded head portions (10), which thread into one or more corresponding threaded apertures (3) in the object, such as a bracket. Each pin (8) has a shank (11) which passes through the aperture (3) in the object (1), and through the substrate (2), such that an end of the shank (11) preferably protrudes through the substrate (2) before the threaded head portion (10) engages the threaded portion of the aperture (3) to lock the pin (8) to the object (1). The apertures (3) in the object (1) may be arranged with their axes at different angles so that the pins (8) pass into the substrate (2) at different angles.

The present invention relates to a fastening assembly for the attachment of objects to substrates formed from friable or other weak materials.

It is generally appreciated that the use of plasterboard as a construction material has introduced difficulties for the support of wall mounted functional and decorative fittings and fixtures such as sinks, light fittings, bathroom furniture, curtain rails etc.

The friable nature of plasterboard means that it tends to crumble around the area adjacent a screw driven therein. This results in a loosening of the screw and thus of any bracket attached to it leaving both liable to fall out.

The problem is particularly acute where substantial load is placed onto the bracket, e.g. bathroom furniture such as a sink, or where the object is subjected to repeated or cyclic stresses.

Previous methods devised to overcome this problem include using large threaded screws or by clamping the bracket against both sides of the plasterboard.

CH693100 describes a bracket bent such that the apertures are aligned at an angle about 30°.

In orthopaedic surgery, it is known to use bracing plates having threaded apertures adapted to retain and lock a fastening screw. As described in US2001021951, these plates are used to brace broken bones to facilitate mending of fractures.

There is provided a kit for supporting an object onto plasterboard or other friable construction material substrate, the kit comprising:

a bracket having an aperture defining a threaded wall;
a fastening means having a shank adapted to pass through the aperture and into the substrate; the fastening means having a threaded portion arranged to be engageable with the threaded wall of the aperture; and
a means associated with the bracket and the fastening means to lock the fastening means to the bracket.

The term ‘bracket’ in the context of this specification will be taken to mean, a support adapted to be affixed to a wall, ceiling or other such surface so as to hold or bear the weight of an object mounted thereon.

Locking of the fastening means directly to the bracket prevents or at least substantially inhibits the ability of the fastening means to move independently from the bracket and therefore improves the bracket's retention to the substrate.

The locking means may be a locking action between the threaded wall of the aperture and the threaded portion of the fastening means. The locking action may take the form of a frictional tightening between the fastening means and the bracket in addition to the frictional contact that is typically experienced between the cooperation of two cylindrical threads.

In a preferred embodiment, the kit comprises a bracket having three or more apertures and comprises three or more fastening means arranged such that each fastening means will protrude into the substrate at an angle divergent from the other two fastening means.

Divergence of the fastening means may be accomplished by the use of at least one aperture having an axis which diverges from perpendicular with respect to the bracket surface. Preferred embodiments also have at least one of the apertures has an axis perpendicular to the bracket surface.

It is favourable that only a portion of the aperture wall is threaded. Preferably the threaded wall is defined within a wider or widening portion of the aperture. It is further preferable that the threaded wall defines a conical helix.

The fixing means may have an enlargened or enlargening head portion, and the threaded portion be defined by the head portion. Again it is preferred that the thread is conically helical.

Having the thread defined on the head allows the fastening means to be partially or fully received within the aperture thereby enabling an object to be mounted onto the bracket without being obstructed by a protruding fastening means.

In a preferred embodiment, the fastening means has a threadless shank. It is also preferred that the head portion defines means, e.g. a suitably shaped recess, engageable by a tool for rotating the fasting means into the substrate.

Experimentation by the inventor has surprisingly found that the use of a threadless shank provides equal if not improved affixing strength of the bracket to the substrate as compared to a standard threaded screw. Although not wishing to be bound to any particular theory, it is thought that a threadless shank causes less deterioration to the integrity of the substrate immediately adjacent the fastening means thereby providing less opportunity for the shank to play within the formed bore hole.

The kit may be used to support any of wall fittings, such as picture or coat hooks; ceiling fittings, such as hanging light fittings; wall fixtures such as wall lights, shelving, wall-mounted televisions or other display screens; supporting bathroom furniture, such as toilet roll holders, towel rails, boilers, cisterns or radiators; and/or curtain rails.

The invention will now be described by way of embodiment with reference to the following figures in which:

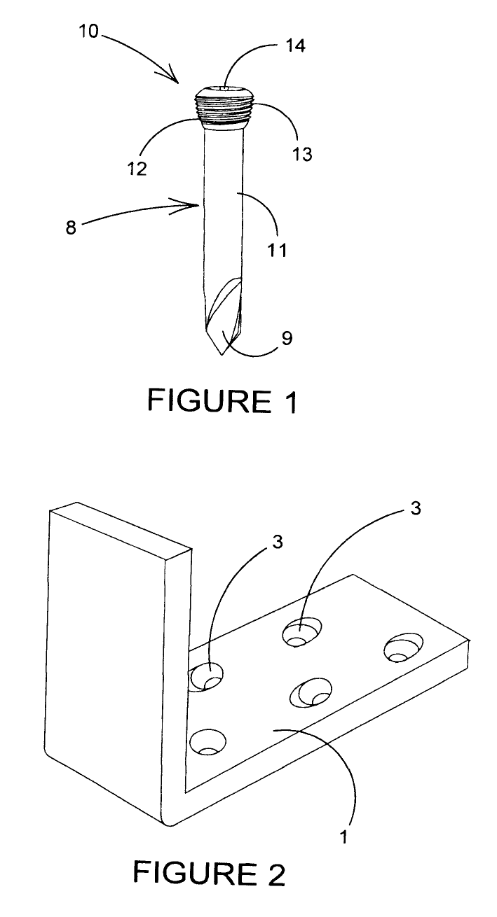

FIG. 1 is a perspective view of a pin for attaching a bracket to a substrate forming part of a wall fixing kit;

FIG. 2 is a perspective view of a bracket having threaded apertures forming part of a wall fixing kit;

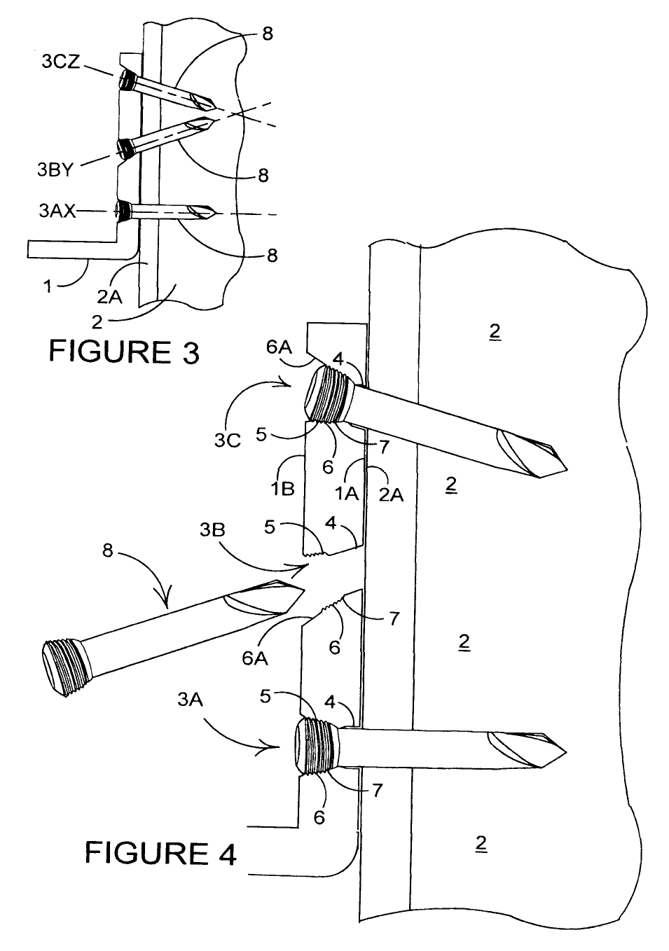

FIG. 3 is a cross section view of a the bracket fixed to a plasterboard wall for supporting a wall fitting or fixture; and

FIG. 4 is a cross-sectional view of the bracket illustrating the apertures in greater detail.

FIG. 2 illustrates an ‘L’ shaped bracket 1 having a flange portion defining five apertures 3.

FIG. 4 illustrates three of these apertures 3 in greater detail. The bracket 1 contacts a relatively flat surface of paper/fibreboard 2A forming the outer layer of a plasterboard substrate 2. Three preformed apertures 3A, 3B, 3C are fashioned to accept and retain a pin 8 in the plasterboard 2 at angles divergent to one another.

Each aperture 3 defines a non-threaded guide portion 4 of substantially constant diameter extending into the body of the bracket 1 from surface 1A contacting the plasterboard 2A. A widening portion 5 extends from the guide portion 4 to form a flared opening in the opposite surface 1B of the bracket 1.

The widened portion 5 is defined by a sloped inside wall 6 supporting a internal conical thread 7.

Aperture 3A is bored with an axis X substantially perpendicular to surface 1B of the bracket 1. Apertures 3B, 3C are bored with axes Y, Z offset from perpendicular, not parallel to the axis X of aperture 3A nor parallel to axes of one another. Additionally the direction of the apertures axes 3 are selected such that at least one axis (X, Y, Z) does not lie within the same or a parallel plane to the other two. As can be seen in FIG. 2, the apertures 3 are spread non-linearly about the flange of the bracket 1.

Where the apertures 3 are bored with non-perpendicular axes, the opening of the apertures 3 will define an extended wall portion 6A substantially on one side of the aperture 3 which may or may not be threaded.

The bracket 1 is held to the substrate by way of pins 8. As illustrated in FIG. 1, each pin 8 defines a cutting portion 9 and an enlarged head portion 10 at either end of a shank 11. Head portion 10 defines shoulders 12 defining a conical external thread 13 having a pitch corresponding with internal thread 7 of widening portion 5. Defined within the end of head portion 10 is a recess 14 shaped for engagement with a tool e.g. screwdriver such as a Philips cross-screw, Allen key etc.

The size of head portion 10 and slope of shoulder portions 12 are chosen to allow the head 10 to seat within the widened portion 5 of aperture 3 such that threads 7, 13 are engagable.

Where possible, the length of the pins are chosen such that the cutting portion 9 will protrude through to the other side of the plasterboard 2 before the threads 7, 13 engage. This is to preclude rotation of the pin 8 causing the bracket to be raised away from the surface of the plasterboard rather than causing the cutting portion 9 to penetrate further into the plasterboard rather than causing the cutting portion 9 to penetrate further into the plasterboard 2. Where an adequate pin length can not be selected because the substrate is very thick, e.g. a breeze block, the hole may be predrilled before the pin is inserted.

To affix the bracket 1 to the substrate 2, the portion of the bracket defining the apertures 3 is held generally flush against the surface of the plasterboard 2A. A pin 8 is first positioned within aperture 3A and driven into the plasterboard as a temporary fix. Perpendicular aperture 3A, enables easier first entry into the plasterboard surface whilst the bracket is not self-supported. The guide portion 4 helps to direct the pin 8 into the plasterboard at the required divergent angle. Cutting portion 9 of the pin 8 acts to bore a channel in the plasterboard 2A, 2 for the shank 11 to pass through. Once the first pin 8A is secured, the remaining pins 8B, 8C etc can be located and driven in.

Each pin 8 is driven until head 10 seats sufficiently into the narrow part of the widen portion that conical threads 7, 12 are engagable. Further driving of the pin 8 causes the shoulder/thread 12, 13 to forcefully abut and be compressed against wall 6, thread 7 such as to induce a circumferential stress in said wall 6. This may also be accompanied by slight plastic deformation of the pin 12, 13 and/or the wall/thread 6/7.

The action of the two conical threads 7, 13 generates a frictional force or tightening in addition to that typically experienced between the cooperation of two cylindrical threads. This additional tightening can be thought of as a locking action.

With the pin 8 locked to the bracket 1, a substantially increased level of torque is required to rotate the pin 8 out from the locked position. This inhibits independent movement of the pin 8 from the plate 1 and vice-versa thereby inhibiting the plate's 1 ability to be moved from its affixed position.

As can be seen in FIGS. 3 and 4, each aperture 3A, 3B, 3C guides each respective pin 8A, 8B, 8C into the plasterboard and locks it therein at angles substantially non-parallel to one another.

Because each of the pins 8 diverge, movement of the bracket 1 away from its fixed position will be will be resisted as the vector of the force will be at least partially transverse to the axis of at least one of the pins. Equally, as the pins are locked to the bracket 1, stress upon the bracket will not allow subsequent movement or play of the pins 8 which would otherwise accelerate loosening.

Modifications of the above assembly are possible, for example, the bracket may comprise any number of apertures 3 for receiving the corresponding number of pins 8, however it is preferred that at least three pins are used to achieve adequate attachment.

Although preferred, it is not necessary for all three pins to diverge and be located in more than one plane. For example, if there are two pins and apertures, they could be parallel, although extending non-perpendicularly to the bracket. In this case, both pins could extend downwardly into the plasterboard, so that the weight of the bracket (and whatever is supported on the bracket) is used to maintain the bracket in position against the plasterboard.

In an alternative embodiment, one, more or each of the apertures may comprise a threaded guide portion 4 or in a further embodiment one, more or each of the apertures may not define a guide portion.

The invention may equally be applied to other forms or shapes of bracket other than ‘L’ shaped.

The locking action may instead be achieved by use of a cylindrical threaded aperture with a conical pin or vice-versa.

Alternatively, the apertures 3 may be provided with bushes having an threaded inner wall which acts as the inner wall of the aperture and received the male thread of the pin. The inner diameter of the bush may be cylindrical and slightly smaller than that of the threaded portion of the pin so that entry of the pin into the bush causes compression of the bush between the 6 of the apertures and the pin head locking the two together.

It will be appreciated that although only a few particular embodiments of the invention have been described in detail, various modifications and improvements can be made by a person skilled in the art without departing from the scope of the present invention. For example, although the apertures have been described as having (at least) a threaded portion, that threaded portion can be produced by the threaded portion of the head of the pin when it is screwed in, if that thread is self-tapping. In this case, the bracket may be made, for example, of plastics material and the apertures, although having a guide portion with an axis at the appropriate angle to guide the pin at the desired angle to the plasterboard, do not have a pre-threaded portion, but merely a portion that becomes threaded as the threaded self-tapping head of the pin reaches the aperture and starts to screw into it.

It will be apparent that the above embodiments of the invention have several advantages over the prior art. In particular, because the shanks of the pins are not threaded, i.e. substantially smooth, they pass through the hole cut into the plasterboard without increasing its size or otherwise interacting with it. Thus, if the pin is rotated too far, for example, and needs to be loosened a bit, or if the bracket, and hence the pins, are stressed, the integrity of the plasterboard is not compromised as much as when threaded screws are loosened or pulled, thereby increasing the size of the hole and the integrity of the plasterboard. This has provided a dramatic increase in resistance to pull out and lateral forces from friable, soft or weak substrates, especially when there are at least three divergent pins. Furthermore, because the holes formed in the substrate are not increased in size by screw threads, if the bracket needs to be removed, for example for repositioning, the remaining holes are relatively small and therefore easier to fill.

By having pins of different lengths available, it is easy to fix the brackets to hollow walls or doors, or to solid ones, even if there is a construction material deeper behind the plasterboard through which the pins cannot pass, e.g. a metal lintel over a door or window frame where a curtain fixing bracket may be placed. In this case, a shorter pin is chosen, which does not reach the metal lintel and the hole formed remains small in diameter and the plasterboard is not damaged as happens when a screw or rawlplug is screwed into a wall and then encounters the lintel, at which point it rotates without moving deeper and damages the hole already made.

Finally, in many instances, precise bracket placement is achieved without the necessity for prior measurement and marking of the wall, because a rapid, easy placement on the wall is achieved, with immediate fixing of the pins to the substrate.

1. A fastening pin for fastening a bracket to a substrate comprising plasterboard or other friable, weak or soft construction material substrate, the pin having a threaded head portion for engagement with the bracket, a non-threaded shank extending from the head portion to a tip having a cutting portion suitable for cutting into the substrate, whereby, when the pin is driven into the substrate, the cutting portion cuts a bore hole into the substrate for the non-threaded shank.

2. A fastening pin according to claim 1, wherein the threaded head portion is enlarged or enlargening from the shank.

3. A fastening pin according to claim 1, wherein the threaded head portion comprises a thread configured in a conical helix.

4. A fastening pin according to claim 1, wherein the head portion defines a tool engageable structure for enabling the pin to be rotated into the substrate using a suitable tool.

5. A kit for supporting an object onto a plasterboard or other friable, weak or soft construction material substrate having a surface to which the object is to be supported, the kit comprising:
at least one fastening pin according to claim 1;
a bracket having a plurality of apertures, at least one of which defines a wall for engagement with the threaded head of the fastening pin;
wherein the shank of the fastening pin is adapted to pass through the aperture and into the substrate and
engagement of the threaded head of the fastening pin with the wall of the aperture in the bracket causes locking of the fastening pin to the bracket.

6. A kit according to claim 5, wherein the bracket has three or more apertures and the kit comprises three or more fastening pins arranged such that each fastening pin will protrude into the substrate at an angle divergent from the other two fastening pins.

7. A kit according to claim 5, wherein at least one of the apertures has an axis which diverges from perpendicular with respect to the substrate surface when the bracket is in position on the substrate surface.

8. A kit according to claim 5, wherein the bracket has a generally planar surface for abutting the substrate surface and at least one of the apertures has an axis which diverges from perpendicular with respect to the bracket surface.

9. A kit according to claim 5, wherein the aperture wall is threaded.

10. A kit according to claim 9, wherein only a portion of the aperture wall is threaded.

11. A kit according to claim 9, wherein the threaded wall is defined within a wider or widening portion of the aperture.

12. A kit according to claim 9, wherein the threaded wall defines a conical helix.

13. A kit according to claim 5, wherein the bracket is configured to support any of wall fittings, wall fixtures, ceiling fittings, supporting bathroom furniture, or curtain rails.

14. A method of supporting an object onto a plasterboard or other friable construction material substrate using a kit according to claim 5.

15. A method according to claim 14, wherein the dimensions of the fastening pins are chosen such that when the fastening pins are passed through the apertures in the bracket and into the substrate, a portion of the pin protrudes through an opposite side of the substrate before the threaded head and aperture wall engage.

16. A method according to claim 15, wherein the shank of the fastening pin is selected to have a length greater than the thickness of the substrate.

17. A method according to claim 14, wherein the fastening pins are passed through pre-formed passages in the substrate.
